(19) United States
(12) Patent Application Publication
(10) Pub. No.: US 2026/0189799 A1
(43) Pub. Date: Jul. 2, 2026

(54) TONE-MAPPING-AWARE AND NOISE-AWARE EXPOSURE CONTROL FOR AN IMAGING SYSTEM

(71) Applicant: Intel Corporation, Santa Clara, CA (US)

(72) Inventors: Andrey Semenjatshenco, Givataim (IL); Dmitry Grilikhes, Rehovot (IL); Naor Cohen, Elyakhin (IL)

(73) Assignee: Intel Corporation, Santa Clara, CA (US)

(21) Appl. No.: 19/546,806

(22) Filed: Feb. 23, 2026

(51) Int. Cl. H04N 23/73; G06T 5/90; H04N 23/71

(52) U.S. Cl. CPC H04N 23/73; G06T 5/90; H04N 23/71; G06T 2207/10144; G06T 2207/30201

(57) ABSTRACT

In imaging systems, automatic exposure (AE) control adjusts scene exposure to place the subject of interest in an image, such as a human face, within a predefined brightness range. Single-exposure AE techniques may struggle to simultaneously lift dark subjects and preserve highlight details, especially in high dynamic range or backlit scenes. An effective AE control technique can compute a target brightness for the subject in a manner that is tone-mapping-aware and noise-aware. The target brightness can be used to derive an exposure setting for the image. The result is comparable to pipelines relying on fusing multiple exposures. The technique lifts dark subjects to a target brightness while preserving highlight detail, providing an efficient and practical solution for real-time imaging on single-exposure sensors.

### BACKGROUND

Cameras are optical systems that capture and record light to create images. A camera can include components such as lenses, sensors, and processing units that process the signals captured by the sensors. Cameras often face image quality issues or artifacts that impact user experience and product value.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an imaging system, according to some embodiments of the disclosure.

FIG. 2 illustrates different possible target brightness values for a subject on a brightness axis, according to some embodiments of the disclosure.

FIG. 3 illustrates one or more components of an image processing unit, according to some embodiments of the disclosure.

FIG. 4 is a flowchart illustrating an algorithm for determining an exposure setting, according to some embodiments of the disclosure.

FIG. 5 is a flowchart illustrating a method for auto-exposure control in a single-exposure pipeline, according to some embodiments of the disclosure.

FIG. 6 showcases an improvement on a captured image using a disclosed auto-exposure control technique, according to some embodiments of the disclosure.

FIG. 7 is a block diagram of an example computing device, according to some embodiments of the disclosure.

### DETAILED DESCRIPTION

### Overview

An imaging system can include a sensor, and an image processing unit that processes the signals captured by the sensor. The sensor may capture a raw image, and the image processing unit may receive the raw image and produce a processed image.

In imaging systems, automatic exposure (AE) control adjusts scene exposure to place the subject of interest in an image, such as a human face, within a predefined brightness range. In high dynamic range (HDR) or backlit scenes, AE control systems encounter a significant technical problem. When the subject is much darker than the background, increasing exposure to meet a target brightness can often result in saturation or clipping of bright regions elsewhere in the image. The AE control system causes irreversible loss of sensor information in highlights and reduces image quality and dynamic range. A particular challenge arises when exposure control is being performed using a single exposure, without relying on multiple captures or HDR fusion techniques. Under these conditions, AE control systems may struggle to simultaneously lift dark subjects and preserve highlight details, especially in high dynamic range or backlit scenes.

Some AE control systems use fixed predefined minimum and maximum target brightness to control scene brightness. When a face is detected, the exposure is adjusted so that the face luminance is raised to at least the minimum target brightness value. This technique works in standard scenes but fails in high dynamic range or backlit scenarios, where the face is significantly darker than the background. In such cases, increasing exposure to meet the fixed minimum target brightness often forces bright background regions into saturation, leading to loss of highlight information. Some AE control systems attempt to address this issue by applying global tone-mapping (TM) after exposure. However, global tone-mapping is done independently of the AE control algorithm. As a result, exposure control and tone-mapping do not cooperate, since AE control may still raise exposure excessively, and tone-mapping cannot recover clipped highlights. While multi-exposure HDR techniques, which capture multiple images at different exposures and then fuse the multiple images to retain both shadow and highlight details, can produce high-quality images, these techniques require more complex capture pipelines, longer processing times, and sometimes specialized hardware. These techniques are unsuitable for single-exposure real-time pipelines, such as those used in many consumer imaging devices.

Implementing an AE control method capable of maintaining optimal subject brightness while preventing highlight saturation in HDR or backlit conditions, without relying on multi-exposure capture or complex hardware, is not trivial. To address this technical challenge, an effective AE control technique can compute a target brightness for the subject, such as a face, in a manner that is tone-mapping-aware and noise-aware. The target brightness can be used to derive an exposure setting for the image.

In some embodiments, the AE control technique determines an optimal target brightness for single-exposure imaging scenarios having a target subject, such as a face, based on one or more of the characteristics of the tone-mapping function applied after exposure. Accounting for the one or more characteristics of the tone-mapping function can ensure that the subject is mapped to a desired post-tone-mapping level of brightness, while also considering noise considerations. Specifically, the technique determines the optimal target brightness based on a critical tone-mapping response of the scene. By analyzing factors such as scene luminance, highlight range, sensor noise, and denoising capabilities, the technique adjusts the target brightness to ensure that tone-mapping can enhance dark regions (e.g., faces) without amplifying noise or causing highlight clipping. The target brightness is adapted in a manner to avoid excessive exposure reduction that would later require strong tone-mapping amplification and thus introduce visible noise and to avoid excessive exposure increase that would cause saturation of highlight regions. The technique to determine the target brightness allows the imaging system to find an optimal balance between preserving highlight details and maintaining a low noise level in key regions. The final exposure setting can be computed to achieve this optimal target brightness, providing improved visibility of target regions while preserving overall scene highlights in single-exposure high dynamic range scenarios.

In some embodiments, the AE control technique determines a target brightness that depends on factors such as the tone-mapping function applied after exposure, the expected noise level at a given exposure, and the noise reduction capability of the denoising filter used in downstream processing. The technique may evaluate how much tone-mapping can brighten the subject while ensuring that exposure is not reduced to a level that would cause excessive noise amplification beyond what the denoising filter can effectively handle. The technique maintains the desired post-tone-mapped brightness while achieving an optimal balance between exposure, noise, and overall image quality.

The technique can operate in a single-exposure pipeline, where tone-mapping is applied to the captured frame but no multiple exposures or HDR fusion is used. The technique improves the quality of single-exposure imaging by achieving better capture of the subject and highlight preservation through coordinated exposure control and tone-mapping. The technique enables more balanced brightness between faces and backgrounds, maintains highlight detail, and enhances perceived image quality in real-time. The technique integrates efficiently into existing image signal processor or image processing unit pipelines of imaging systems, making it well suited for devices and applications where only a single exposure is available. The result is comparable to pipelines relying on fusing multiple exposures. The technique lifts dark subjects to a target brightness while preserving highlight detail, providing an efficient and practical solution for real-time imaging on single-exposure sensors.

While many embodiments herein are described with respect to camera exposure control, it is envisioned by the disclosure that the teachings can be extended to exposure control of other sensor systems, such as depth sensor systems, range sensing systems, infrared sensing systems, etc.

### Example Imaging Systems

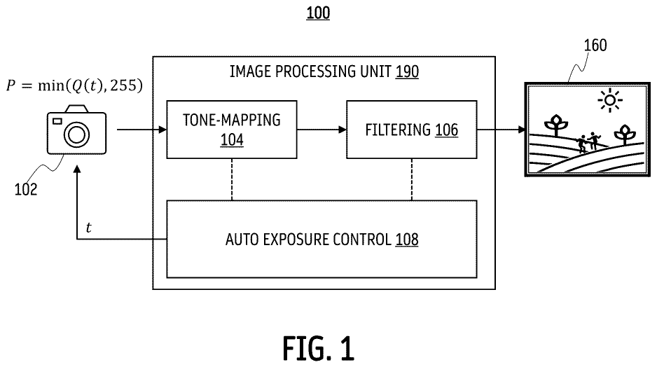

FIG. 1 illustrates imaging system 100, according to some embodiments of the disclosure. Imaging system 100 includes image sensor 102 and image processing unit 190. Image processing unit 190 can generate resulting image 160. Image processing unit 190 comprises one or more of: tone-mapping 104, filtering 106, and auto-exposure control 108.

Image sensor 102 converts light from a scene into pixel signals. Image sensor 102 can include a two-dimensional array of light-sensitive pixels (e.g., photodiodes) that integrate incoming photons over an exposure interval to accumulate charge, and readout circuitry that converts accumulated charge into pixel values of a raw image delivered to image processing unit 190. Because pixel wells and digital output ranges are finite, image sensor 102 can saturate: as exposure increases, collected charge rises approximately linearly until a maximum level is reached, at which point highlight information clips. This saturation behavior of a pixel value can be characterized as a clipped function such as: P=min(Q(t), Pₘₐₓ), where t is exposure time and Pₘₐₓ is a maximum representable pixel value, such as 255 for an 8-bit pixel value. The clipped function is referred to as a pixel formation model.

Image sensor 102 can be implemented using different sensor technologies and shutter modes. Image sensor 102 can be a complementary metal-oxide-semiconductor (CMOS) image sensor, which supports fast readout and flexible control, or a charge-coupled device (CCD) image sensor, which transfers charge for readout using different internal mechanisms. Image sensor 102 can operate with global shutter behavior (pixels integrate simultaneously) or rolling shutter behavior (rows integrate sequentially). For various implementations of image sensor 102, pixels integrate light over a controlled interval, e.g., t, and can clip at an upper limit. In some embodiments, image sensor 102 provides image data and/or statistics that downstream logic can use to judge scene brightness, highlight headroom, and risk of saturation.

Exposure setting for image sensor 102 is controlled by one or more of: integration time (e.g., exposure time t), analog gain, and digital gain. Integration time directly sets how long pixels collect charge and therefore strongly controls saturation risk. Analog and digital gains scale signals but cannot recover clipped highlights and can amplify noise.

Tone-mapping 104 can include linear or non-linear brightness mapping logic to apply a tone-mapping function. Examples of mapping logic can include gamma curves, arctangent-based tone curves, or lookup-table-based tone-mapping logic. Tone-mapping 104 can boost darker pixel values more than brighter pixel values. Tone-mapping 104 can include a tone-mapping logic to apply a tone-mapping function to an image from image sensor 102. Tone-mapping 104 can include one or more of: a parametric or parameterizable tone-mapping function, programmable lookup table, and inverse-mapping or estimation logic. Tone-mapping 104 can include functionality that maps pre-tone-mapping brightness values associated with a target region to a post-tone-mapping brightness target, such that the desired output brightness can be achieved without requiring a proportional exposure increase.

Filtering 106 can include image conditioning logic such as spatial denoising, temporal noise reduction across frames, edge-aware smoothing, or sharpening. Filtering 106 may apply a filter to an output image of tone-mapping 104. Filtering 106 can include a filtering logic to apply a filter to an output image from tone-mapping 104. In some cases, the filtering logic may apply one or more filters. The one or more filters may have one or more characteristics. Filtering 106 can include one or more of: spatial denoiser, temporal denoiser, bilateral filter, and artifact suppression logic. Filtering 106 can include noise reduction operations that mitigate noise amplified by tone-mapping 104 or other image processing process(es) in image processing unit 190. Filtering 106 can also include conditioning operations that suppress banding, quantization artifacts, or ringing introduced by tone-mapping 104 or other image processing process(es) in image processing unit 190.

Resulting image 160 comprises processed image data generated by image processing unit 190 after application of tone-mapping 104 and filtering 106. Resulting image 160 can represent a final output image stored in memory, transmitted to another processing stage, or provided to an application pipeline.

In some embodiments, imaging system 100 may operate in single-exposure mode in which auto-exposure control 108 selects an exposure setting, e.g., t, while tone-mapping 104 and filtering 106 cooperatively produce resulting image 160 with a target region captured at desired target brightness.

Auto-exposure control 108 can include control logic that determines an exposure setting t for image sensor 102 using scene statistics and anticipated behavior or response of tone-mapping 104 and filtering 106, enabling exposure setting determination that avoids highlight saturation while allowing downstream brightness recovery. Phrased differently, auto-exposure control 108 determines or adapts the exposure setting t in a manner that is influenced by or accounts for the behavior or response of tone-mapping 104 and filtering 106, to avoid unwanted artifacts and degradation in image quality in resulting image 160.

In some embodiments, auto-exposure control 108 adjusts exposure settings, e.g., integration time or exposure time t, to place a target region into a desired brightness range while limiting highlight clipping. Auto-exposure control 108 can choose a lower target brightness, thus a lower exposure time, to preserve highlight detail in image sensor 102 output and rely on tone-mapping 104 (and filtering 106) to lift darker regions afterward, achieving desired perceived brightness in resulting image 160 without sacrificing highlight information.

In some embodiments, auto-exposure control 108 may compute a tone-mapping-aware minimum brightness by inverting a conservative or critical tone-mapping curve implemented by tone-mapping 104, enabling coordination between exposure setting t and non-linear brightness amplification. In some examples, auto-exposure control 108 may account for noise reduction capability associated with filtering 106 when determining exposure setting t, preventing exposure reductions that would produce noise levels beyond the capabilities of filtering 106.

### Illustrative Target Brightness Values Along a Brightness Axis

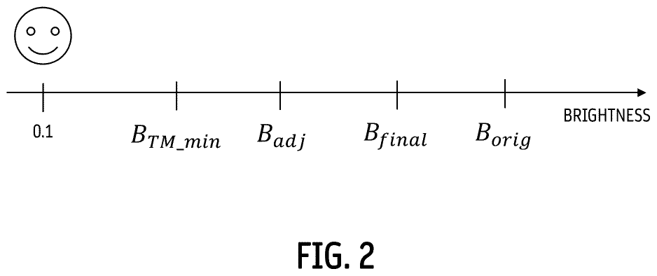

FIG. 2 illustrates different possible target brightness values for a subject on a brightness axis, according to some embodiments of the disclosure. The different possible target brightness values illustrate how multiple target brightness levels are defined and used to control exposure in a tone-mapping-aware imaging system. The subject may include a face of a human. The subject may include a salient subject in a scene.

The leftmost point on the brightness axis represents an initial measured brightness value of the subject, e.g., represented by a small value such as 0.1. The value may be low or dark. The rightmost point on the brightness axis, B_{orig}, represents a conventional or original auto-exposure target brightness value that would be used (e.g., a brightness value that is determined independently from the tone-mapping function). While B_{orig} may offer optimal noise performance, directly targeting B_{orig} in high dynamic range or backlit scenes can lead to irreversible highlight clipping.

Moving rightward along the brightness axis corresponds to increasing pre-tone-mapping brightness achieved through exposure control. In some embodiments, the auto-exposure control system determines one or more intermediate brightness values that reflect downstream tone-mapping capability, noise constraints, and preservation of highlight regions. Specifically, FIG. 2 highlights that exposure control is not driven directly to B_{orig}, but instead, exposure control is guided through B_{TM_min}, constrained by B_{adj}, and safely advanced toward B_{orig} only when scene conditions permit, enabling coordinated exposure and tone-mapping in a single-exposure imaging pipeline. Strategic and deliberate increase of target brightness value along the brightness axis enables smooth adaptation without abrupt exposure changes.

Brightness value B_{TM_min} represents a tone-mapping limited minimum brightness for the subject. B_{TM_min} can be determined by inverting a conservative or critical tone-mapping function to find the lowest pre-tone-mapping brightness that can still be mapped, after tone-mapping, to a desired post-tone-mapping brightness for the subject. B_{TM_min} can define a hard lower bound for the exposure setting. If an exposure setting produces brightness below B_{TM_min}, even the strongest allowable tone-mapping would be insufficient to reach the intended output brightness. By anchoring exposure control at or above B_{TM_min}, the auto-exposure control system ensures feasibility of downstream brightness recovery while avoiding unnecessary exposure increases that could cause highlight saturation.

Brightness level B_{adj} represents a noise-aware adjusted minimum brightness. Although B_{TM_min} is sufficient from a tone-mapping perspective, reducing the exposure setting to B_{TM_min} may amplify sensor noise beyond acceptable limits once tone-mapping is applied. B_{adj} is therefore selected at or above B_{TM_min} to satisfy noise and denoising constraints, while still remaining as low as possible to preserve highlight headroom. B_{adj} acts as a safe operating point that balances tone-mapping capability and noise robustness and serves as a lower bound for subsequent brightness value determination or selection.

Brightness level B_{final} represents the brightness value for the subject that is to be used by auto-exposure control for a given frame. B_{final} can be chosen between B_{adj} and an original brightness value B_{orig} based on available highlight headroom in the scene. When scene statistics indicate that increasing exposure will not cause significant saturation, B_{final} can be progressively and strategically increased toward B_{orig}. When highlights are at risk, B_{final} remains closer to B_{adj} to protect highlight detail.

### Example Logic or Components in an Image Processing Unit

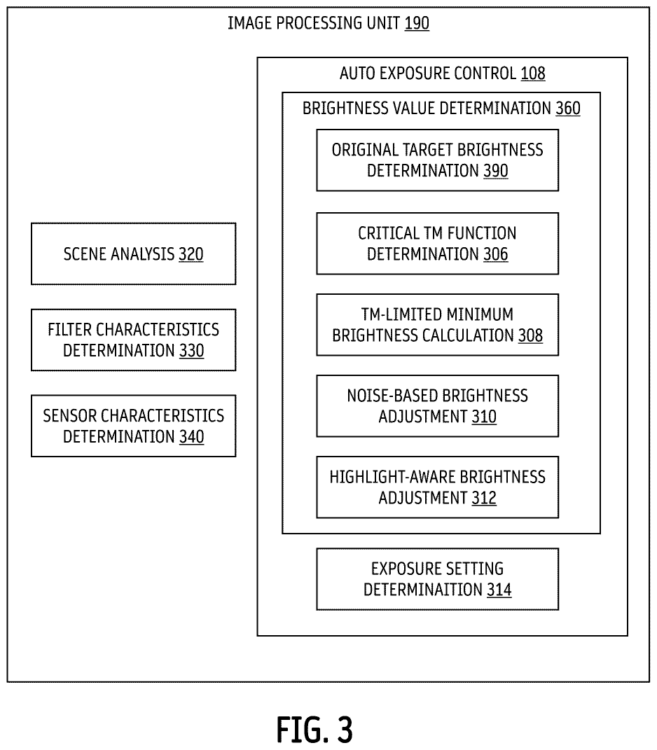

FIG. 3 illustrates one or more components of image processing unit 190, according to some embodiments of the disclosure. Image processing unit 190 comprises one or more of: auto-exposure control 108, scene analysis 320, filter characteristics determination 330, and sensor characteristics determination 340.

In some examples, image processing unit 190 may integrate scene analysis 320, filter characteristics determination 330, and sensor characteristics determination 340 with auto-exposure control 108 to enable coordinated decision-making across capture and processing stages. This integration allows exposure to be reduced to protect highlights while relying on tone-mapping and filtering to restore perceived brightness, achieving improved single-exposure image quality compared to fixed-target auto-exposure systems.

Scene analysis 320 can include logic that extracts one or more scene statistics, such as luminance distributions, target region or subject brightness, and highlight occupancy (e.g., available highlight headroom), or other scene-dependent information, before exposure setting changes. The one or more scene statistics or other scene-dependent information are used to guide exposure control decisions. In some embodiments, scene analysis 320 is performed before adjusting the exposure setting, so that highlight information is not lost to saturation. Scene analysis 320 can obtain luminance distributions from captured image data, such as histograms or cumulative distributions, representing brightness values prior to tone-mapping. From these distributions, scene analysis 320 can determine target region or subject brightness (e.g., average or representative brightness of a detected face or object of interest) and evaluate highlight occupancy, including a proportion of pixels near saturation or a margin between observed maximum luminance and a sensor saturation threshold (e.g., a percentage of pixels near saturation). In some examples, scene analysis 320 may further estimate available highlight headroom by predicting how pixel values would scale under increased exposure prior to clipping, thereby enabling forward-looking assessment of saturation risk when exposure is adjusted toward higher brightness targets.

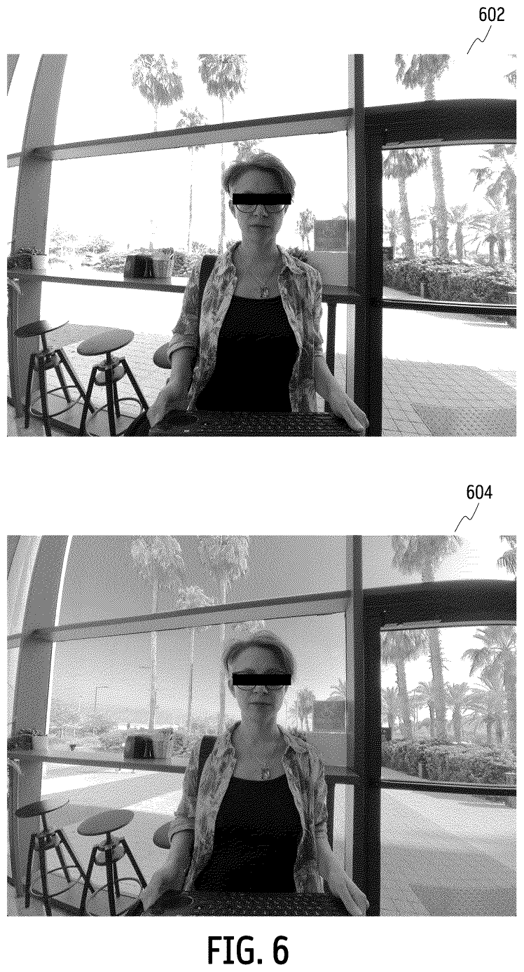

Filter characteristics determination 330 can include logic that characterizes the noise reduction capability of downstream filtering (e.g., in filtering 106 of FIG. 6) applied after capture and tone-mapping. Filter characteristics determination 330 can determine limits on noise amplification that can be effectively attenuated by filtering, such as denoiser strength, maximum tolerable noise variance, noise attention limits, or allowable post-tone-mapping signal-to-noise ratio. One or more filter characteristics can be obtained from pre-characterized device parameters, calibration data, or configuration settings associated with spatial, temporal, or edge-aware denoising operations. In some embodiments, filter characteristics determination 330 may evaluate noise handling capability in conjunction with expected tone-mapping gain, recognizing that aggressive tone-mapping applied to low-brightness regions can amplify sensor noise, and may therefore constrain how far exposure can be reduced while still allowing downstream filtering to produce acceptable image quality. In some embodiments, filter characteristics determination 330 determines the effective denoising strength of the filtering. In some embodiments, filter characteristics determination 330 determines a noise tolerance, e.g., a maximum acceptable input noise level.

Sensor characteristics determination 340 can include logic that determines sensor dynamic range, saturation behavior, and noise properties used to constrain exposure decisions. Sensor characteristics determination 340 can include logic configured to determine physical and/or noise-related properties of an image sensor that constrain exposure selection. Sensor characteristics determination 340 can characterize sensor dynamic range, saturation behavior, and full-well or digital clipping limits, enabling modeling of pixel formation behavior in which accumulated charge increases approximately linearly with exposure time until saturation occurs. Sensor characteristics determination 340 can further determine one or more sensor noise properties, including one or more of shot noise, read noise, and noise variation with exposure or gain settings. In some embodiments, this sensor-specific information is used together with filter characteristics determination 330 to define allowable exposure reductions and maximum tone-mapping strength, ensuring that exposure control decisions preserve highlight information while maintaining noise levels within recoverable limits for downstream processing.

Auto-exposure control 108 comprises one or more of: brightness value determination 360 and exposure setting determination 314. Auto-exposure control 108 can coordinate exposure setting selection with downstream tone-mapping and filtering (e.g., as illustrated in FIG. 1) rather than relying on fixed brightness targets. In some embodiments, auto-exposure control 108 may operate in a single-exposure imaging pipeline and determine an exposure setting that preserves highlight detail while achieving reasonable subject brightness after tone-mapping. In some embodiments, brightness value determination 360 includes a brightness value determination logic to determine a brightness value for a subject of the image based on the tone-mapping function and a characteristic of the filter. In some embodiments, determination 314 includes an exposure setting determination logic to determine an exposure setting for the image sensor based on the brightness value.

Brightness value determination 360 comprises one or more of: original target brightness determination 390, critical TM function determination 306, TM-limited minimum brightness calculation 308, noise-based brightness adjustment 310, and highlight-aware brightness adjustment 312. Brightness value determination 360 can compute one or more intermediate brightness levels that collectively guide exposure control toward a safe and optimal operating point, as illustrated in FIG. 2. In some examples, brightness value determination 360 may produce a final target brightness that is dynamically adapted per frame or per multiple frames based on scene conditions.

Original target brightness determination 390 includes logic to determine an original or baseline brightness value, e.g., B_{orig}, for the subject based on a fixed auto-exposure objective and independent of tone-mapping-awareness. Original target brightness determination 390 can establish a desired, upper-bound, pre-tone-mapping brightness value for the subject, such as a detected face or object of interest, based on predefined luminance targets, user preferences, or device tuning parameters. The original target brightness can represent a brightness level that would be selected by an auto-exposure algorithm to maximize signal-to-noise ratio and overall image clarity under nominal scene conditions, without regard to downstream non-linear tone-mapping or highlight preservation constraints. In some examples, original target brightness determination 390 may rely on fixed or slowly varying thresholds associated with acceptable capture of the subject, and may be derived from calibration data, standards-based exposure targets, or historical tuning of the imaging pipeline. Although the original target brightness provides a desirable upper-bound for exposure selection, one or more subsequent processing stages in brightness value determination 360 are implemented to constrain or modify the brightness value based on tone-mapping feasibility, noise considerations, and highlight headroom. Therefore, the original target brightness serves as a reference point toward which exposure can be safely and progressively adjusted when scene conditions permit.

Critical TM function determination 306 can identify a conservative or critical tone-mapping function, e.g., ƒ_{crit}, that represents maximum allowable non-linear amplification consistent with noise and denoising constraints. In some embodiments, critical TM function determination 306 may select a minimum gamma value Y crit or maximum lookup-table (LUT) gain that bounds downstream tone-mapping behavior, e.g., behavior of tone-mapping 104 of FIG. 1. Critical TM function determination 306 can include a tone-mapping function determination logic to estimate a parameter of the tone-mapping function based on one or more of a subject signal level, a noise characteristic of the image sensor, and a target signal-to-noise ratio. The subject signal level, the noise characteristic of the image sensor, and the target signal-to-noise ratio can be determined by image processing unit 190.

In practice, one or more parameters of the TM function, such as gamma value γ_{crit} or lookup-table (LUT) gain, are not known a priori or before exposure computation time. The one or more parameters may vary with one or more factors, such as scene content, device tuning, and sensor conditions. Relying on a fixed or idealized TM function to characterize the TM behavior may lead to incorrect pre-tone-mapping brightness value computation and unstable exposure behavior. To ensure robust operation, critical TM function determination 306 estimates a conservative or critical TM function parameter for a given frame to present a maximum expected tone-mapping strength based on characteristics such as noise levels, signal strength in the subject region, sensor noise characteristics, and scene luminance statistics. The estimated TM function parameter represents the most aggressive tone-mapping that could be applied while maintaining acceptable image quality, particularly with respect to noise amplification in darker regions. In some embodiments, critical TM function determination 306 determines this conservative or critical tone-mapping function parameter by analyzing scene statistics and/or sensor characteristics, as determined by one or more of scene analysis 320, filter characteristics determination 330, and sensor characteristics determination 340. In some embodiments, critical TM function determination 306 may take into account, for example, the signal level in the subject region, read and/or shot noise levels of the image sensor, and a target signal-to-noise ratio after tone-mapping. The resulting parameter represents the maximum tone-mapping lift that can be applied without unacceptable noise amplification.

The determined parameter can be used to construct or form the critical tone-mapping function or curve, e.g., ƒ_{crit}. This critical tone-mapping curve determined by critical TM function determination 306 is used by TM-limited minimum brightness calculation 308 to compute the pre-tone-mapping minimal target brightness, e.g., B_{TM_min} for exposure control. By basing the calculation of target brightness, e.g., utilizing the lower bound minimum brightness value or B_{TM_min} on this conservatively estimated tone-mapping function or curve, auto-exposure control 108 can ensure that exposure decisions made in exposure setting determination 314 reflect realistic post-processing behavior. Utilizing the tone-mapping-aware brightness value estimated based on a conservative tone-mapping function can lead to more stable and predictable subject brightness across varying scenes, while avoiding unnecessary overexposure or highlight loss.

In some embodiments, the determination of the parameter for the critical tone-mapping function is optional. In some embodiments, the critical tone-mapping function may be determined or selected based on one or more heuristics of the imaging system.

TM-limited minimum brightness calculation 308 can determine a minimum pre-tone-mapping brightness value, e.g., B_{TM_min}, that, when processed by a critical tone-mapping function, e.g., ƒ_{crit}, reaches a desired post-tone-mapping target brightness. TM-limited minimum brightness calculation 308 can establish a hard lower bound on exposure for the subject, below which tone-mapping cannot recover target brightness. TM-limited minimum brightness calculation 308 can determine the brightness value, e.g., B_{TM_min} based on the tone-mapping function and the parameter of the tone-mapping function, such as ƒ_{crit}. Given a target post-tone-mapping brightness value or original or baseline brightness value, e.g., B_{orig}, and a critical tone-mapping function, e.g., y=ƒ_{crit}(x), where x∈[0,1] is a pre-tone-mapping normalized intensity, and y∈[0,1] is a post-tone-mapping normalized intensity, TM-limited minimum brightness calculation 308 can determine the input value, or pre-tone-mapping brightness value or intensity x* such that ƒ_{crit}(x*)=B_{orig}. TM-limited minimum brightness calculation 308 can solve for x* such that

$${f}_{crit} ( {x}^{*} ) = {B}_{orig} .$$

In some cases, ƒ_{crit} is a parameterizable analytic function, e.g., a gamma function, or ƒ_{crit}(x)=x^{γ}^{_{crit}}. If ƒ_{crit} is an analytic function, TM-limited minimum brightness calculation 308 can calculate x* by inverting the function. The solution for x is:

$${x}^{*} = {B}_{orig}^{1 / {γ}_{crit}} .$$

The value for x* represents a pre-tone-mapping intensity or brightness value, e.g., B_{TM_min}, that can hit the target post-tone-mapping brightness value or original or baseline brightness value, e.g., B_{orig}.

In some cases where ƒ_{crit} is a complex tone-mapping function where no closed-form inverse exists, or is represented as an LUT (e.g., arctan-based LUT), TM-limited minimum brightness calculation 308 can solve for x* by solving for ƒ_{crit}(x*)−B_{orig}=0. In some embodiments, TM-limited minimum brightness calculation 308 may determine x* through binary search. In some embodiments, TM-limited minimum brightness calculation 308 may determine x* through LUT inversion. In some embodiments, TM-limited minimum brightness calculation 308 may determine x* numerically (e.g., Newton-Raphson, bisection, or LUT search). In some embodiments, TM-limited minimum brightness calculation 308 may determine x* through binary search in a precomputed LUT. A numerical approach or LUT search approach can work for arbitrary monotonic tone-mapping curves.

Noise-based brightness adjustment 310 can increase the brightness value above a TM-limited minimum brightness, e.g., B_{TM_min}, when exposure reduction would cause unacceptable noise amplification after tone-mapping. In some examples, noise-based brightness adjustment 310 may use one or more filter characteristics of filtering 106 of FIG. 1, determined by filter characteristics determination 330, to ensure the selected brightness remains within noise-handling capability. Noise-based brightness adjustment 310 can determine the brightness value, e.g., B_{adj}, based on a noise amplification constraint. The noise amplification constraint is based on one or more of a noise characteristic of the image and the characteristic of the filter. In some embodiments, noise-based brightness adjustment 310 may adjust the brightness value, e.g., B_{TM_min}, determined in TM-limited minimum brightness calculation 308, if a predicted noise, such as at the present exposure or brightness, exceeds the denoising model's effective range. Adjusting the brightness value upwards, where B_{adj}>B_{TM_min}, can avoid noise amplification after tone-mapping.

In some embodiments, noise-based brightness adjustment 310 can select a noise-constrained adjusted brightness B_{adj} based on a tone-mapping-limited minimum brightness B_{TM_min} (as determined in TM-limited minimum brightness calculation 308) and noise tolerance of downstream processing (as determined in one or more of scene analysis 320, filter characteristics determination 330, and sensor characteristics determination 340). Noise-based brightness adjustment 310 can receive a tone-mapping-limited minimum brightness B_{TM_min}, representing a lowest pre-tone-mapping brightness at which a conservative tone-mapping function can still achieve a desired post-tone-mapping target brightness. Noise-based brightness adjustment 310 can further evaluate expected noise amplification resulting from applying tone-mapping to image data captured at or near B_{TM_min}, using sensor noise characteristics and filtering capability information. When noise amplification at B_{TM_min} is determined to exceed acceptable limits, such as exceeding denoiser capability or a target signal-to-noise ratio, noise-based brightness adjustment 310 can increase the brightness above B_{TM_min} to a level, e.g., B_{adj}, at which post-tone-mapping noise remains recoverable by downstream filtering. In this manner, B_{adj} can be selected as a lowest pre-tone-mapping brightness that satisfies tone-mapping feasibility and noise acceptability constraints, such that B_{adj}>B_{TM_min} and further exposure reduction below B_{adj} would lead to excessive noise amplification even if tone-mapping could nominally restore brightness. Noise-based brightness adjustment 310 thus establishes B_{adj} as the brightness value that represents a noise-aware lower bound for exposure control, providing a safe operating point from which exposure may later be increased when highlight conditions permit, while preventing selection of exposure levels that would degrade image quality due to irrecoverable noise.

In some embodiments, the adjustment of the brightness value based on a noise constraint is optional. In some embodiments, the adjustment of the brightness value is done by an amount, where the amount is determined or selected based on one or more heuristics of the imaging system.

Highlight-aware brightness adjustment 312 can selectively increase brightness toward an original auto-exposure target brightness value, e.g., B_{orig}, when scene analysis 320 indicates sufficient highlight headroom. In some embodiments, highlight-aware brightness adjustment 312 may compute a blending factor, e.g., a, that smoothly interpolates between a noise-aware minimum brightness, e.g., B_{adj}, and an original brightness target, e.g., B_{orig}, to improve signal-to-noise ratio without introducing highlight clipping. Highlight-aware brightness adjustment 312 can determine the brightness value based on one or more of an amount of highlight in the image (as determined in scene analysis 320) and a tone-mapped brightness value of the subject of the image, e.g., B_{orig}. Highlight-aware brightness adjustment 312 can comprise a blending logic to determine a blending parameter, e.g., a, for blending the brightness value, e.g., B_{adj}, and a tone-mapped brightness value of the subject of the image, e.g., B_{orig}, based on an amount of highlight in the image.

In some embodiments, if increasing exposure or brightness value towards B_{orig} would not cause significant highlight saturation, then the brightness value, e.g., B_{final}, can be increased towards the original target brightness value, e.g., B_{orig}, such that B_{adj}<B_{final}≤B_{orig}. The adjustment in brightness value, or the interpolation between B_{adj} and B_{orig} can be calculated as follows:

$${B}_{final} = {B}_{adj} + α ( {B}_{orig} - {B}_{adj} ) = ( 1 - α ) {B}_{adj} + α {B}_{orig}$$

α∈[0,1] and a depends on the available highlight headroom. α is a blending weight or interpolation weight/factor that is determined based on the available highlight headroom. If increasing exposure or brightness value towards B_{orig} would cause significant highlight saturation, then the brightness value is set to the noise-aware and tone-mapping-aware brightness value or the noise-constrained adjusted brightness value, e.g., B_{final}=B_{adj}.

Highlight-aware brightness adjustment 312 can selectively increase brightness above a noise-constrained adjusted brightness B_{adj} based on the availability of highlight headroom in a scene. Highlight-aware brightness adjustment 312 can evaluate highlight occupancy and predicted saturation behavior using scene analysis information, such as luminance distributions and proximity of pixel values to a sensor saturation threshold, to determine whether increasing exposure would result in unacceptable clipping of bright regions. When sufficient highlight headroom is available, highlight-aware brightness adjustment 312 can progressively increase brightness toward an original target brightness B_{orig} to improve signal-to-noise ratio and overall image quality. When highlight headroom is limited, highlight-aware brightness adjustment 312 can constrain brightness to remain at or near B_{adj} to preserve highlight detail. In some examples, highlight-aware brightness adjustment 312 can compute a blending factor that interpolates between B_{adj} and B_{orig} as a function of predicted saturation, enabling smooth, gradual exposure changes rather than abrupt transitions. By operating on image data captured prior to saturation, highlight-aware brightness adjustment 312 enables forward-looking prediction of highlight clipping under increased exposure and ensures that exposure is increased only when scene conditions permit, thereby balancing highlight preservation and noise reduction within a single-exposure imaging pipeline.

While the tone-mapping- and noise-aware minimal target brightness value B_{adj} provides a conservative estimate that prevents highlight saturation, maintaining exposure control strictly at this level may lead to unnecessarily low exposure in scenes where highlight clipping is not a concern. To address this scenario, highlight-aware brightness adjustment 312 implements an adaptive interpolation mechanism that blends the tone-mapping-based target brightness B_{adj} with the original fixed minimal target brightness B_{orig} based on the amount of available highlight in the scene. Scene analysis 320 can analyze the current frame's highlight distribution, such as the percentage of pixels already saturated or those predicted to saturate if exposure were increased toward B_{orig}. When sufficient highlights exist (e.g., few or no pixels are near clipping), highlight-aware brightness adjustment 312 gradually shifts the exposure target (e.g., the brightness value) toward the original target brightness B_{orig} by appropriately selecting the blending parameter α. Conversely, when many pixels approach saturation, highlight-aware brightness adjustment 312 maintains exposure (e.g., the brightness value) near the tone-mapping-based target brightness B_{adj} to preserve highlight detail.

In some embodiments, the adjustment based on available highlight headroom may alternatively be applied to the target average luminance value that correlates with this target brightness, allowing interpolation in exposure space rather than target brightness space.

In some embodiments, examples of strategies for determining α include:
Saturation-ratio method: When the proportion of saturated pixels is low (large highlight), α approaches 1. When many pixels are near saturation, α approaches 0.
Linear mapping: α increases smoothly as highlight grows, ensuring gradual transitions.
Tone-mapped histogram simulation: α is estimated by predicting the post-tone-mapping histogram response to a hypothetical exposure increase.

In some embodiments, scene analysis 320 estimates the amount of highlight headroom or the amount of highlight details from the scene's histogram. In scenes where the luminance distribution extends into the saturation range, highlight-aware brightness adjustment 312 sets a smaller value for a to maintain exposure near the tone-mapping-based target brightness B_{adj}. When the histogram shows no pixels near the upper limit, indicating available highlight range, highlight-aware brightness adjustment 312 sets a larger value for a to allow the exposure to approach the original target brightness B_{orig} without risking highlight clipping.

The tone-mapping-based target brightness B_{adj} acts as a safe lower bound on exposure, ensuring highlight preservation. The adaptive interpolation in highlight-aware brightness adjustment 312 allows the exposure system to raise the target brightness value for the subject toward B_{orig} when the scene permits, maximizing signal-to-noise ratio and overall image quality. This adaptive blending makes the algorithm responsive in both directions, e.g., reducing exposure in backlit or high-contrast scenes to protect highlights and increasing exposure in balanced scenes to enhance the capture of the subject.

In some embodiments, the adjustment of the brightness value based on highlight headroom is optional. In some embodiments, the adjustment of the brightness value is done by an amount, where the amount is determined or selected based on one or more heuristics of the imaging system.

Exposure setting determination 314 can convert a final brightness value, e.g., B_{final} produced by brightness value determination 360 into an exposure setting applied to an image sensor. Exposure setting determination 314 can account for sensor characteristics provided by sensor characteristics determination 340, including saturation limits and linear exposure response. In some embodiments, determination 314 computes an exposure gain or exposure time t that would map the subject region to the final brightness value, e.g., B_{final}, in a pre-tone-mapping domain. The exposure setting is output and used to set the imaging system for the frame, e.g., a current frame or a future frame.

### Example Algorithm for Auto-Exposure Control

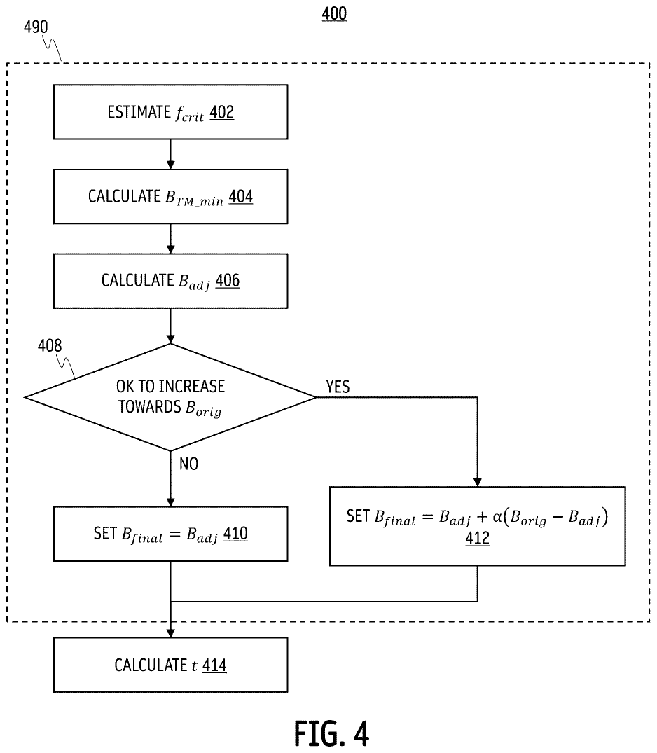

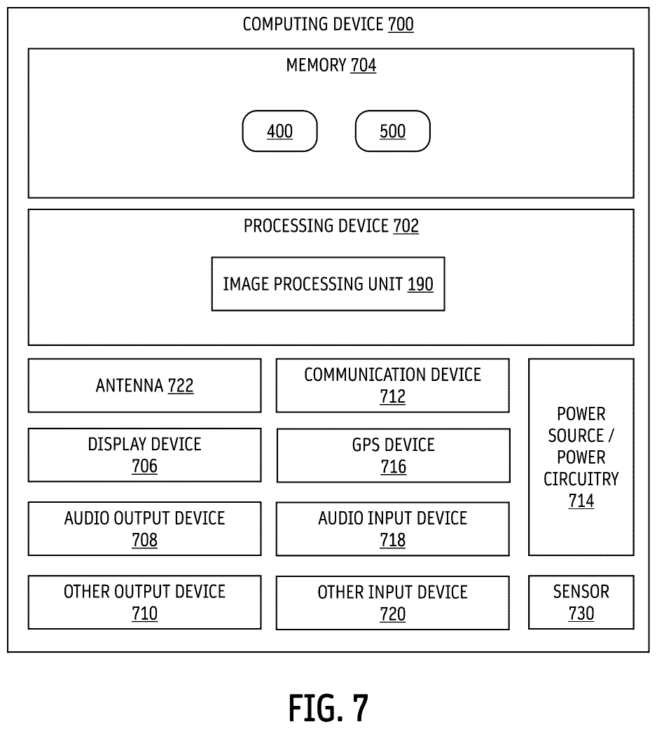

FIG. 4 is a flowchart illustrating algorithm 400 for determining an exposure setting, according to some embodiments of the disclosure. Algorithm 400 can be implemented or carried out by one or more components or logic of image processing unit 190 as illustrated in FIGS. 1 and 3. Algorithm 400 can be encoded in instructions, that can be executed by image processing unit 190, and stored in one or more non-transitory computer-readable media. Algorithm 400 can be implemented as part of firmware for image processing unit 190. Algorithm 400 can be performed using a computing device, such as computing device 700 in FIG. 7.

Algorithm 400 includes operation 490 that determines a brightness value, e.g., B_{final}, for a subject of an image based on a tone-mapping function and a characteristic of a filter being applied to the image after the tone-mapping function is applied to the image, and operation 414 that determines an exposure setting, e.g., t, for an image sensor based on the brightness value.

In operation 402, ƒ_{crit} is estimated. The tone-mapping function is estimated by estimating a parameter, e.g., γ_{crit} or LUT-gain, of the tone-mapping function based on one or more of a subject signal level, a noise characteristic of the image sensor, and a target signal-to-noise ratio.

In operation 404, B_{TM_min} is calculated by determining an input value, e.g., x*, to the tone-mapping function, e.g., ƒ_{crit}, that results in a tone-mapped brightness value of the subject of the image, e.g., B_{orig}.

In operation 406, B_{adj} is calculated by determining a noise amplification constraint based on one or more of a noise characteristic of the image and the characteristic of the filter, and adjusting the brightness value based on the noise amplification constraint.

In operation 408, it is determined whether it is okay to increase the brightness value towards the tone-mapped brightness value of the subject of the image, e.g., B_{orig}. The determination can involve determining the amount of available highlight headroom. If yes, algorithm 400 proceeds to operation 412. If no, algorithm 400 proceeds to operation 410.

In operation 412, B_{final} is set to a blended combination of B_{adj} and B_{orig} based on a blending parameter α. In some embodiments, algorithm 400 determines an amount of highlight in the image. Algorithm 400, based on the amount of highlight meeting a condition, increases the brightness value, e.g., B_{adj}, towards a tone-mapped brightness value of the subject of the image, e.g., B_{orig}. In some embodiments, algorithm 400 adapts an interpolation parameter α based on an amount of highlight in the image. Algorithm 400 interpolates the brightness value, e.g., B_{adj}, and a tone-mapped brightness value of the subject of the image, e.g., B_{orig} according to the interpolation parameter α.

In operation 410, B_{final} is set to B_{adj}.

In operation 414, an exposure setting, e.g., exposure time t is calculated, based on B_{final}.

### Example Method for Auto-Exposure Control

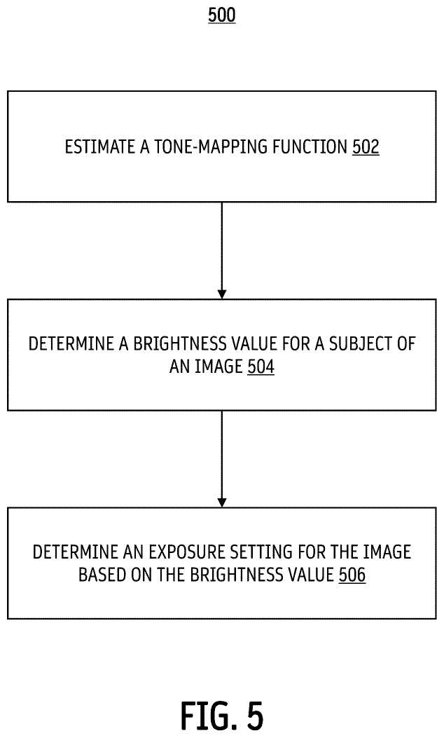

FIG. 5 is a flowchart illustrating method 500 for auto-exposure control in a single-exposure pipeline, according to some embodiments of the disclosure. Method 500 can be implemented or carried out by one or more components or logic of image processing unit 190 as illustrated in FIGS. 1 and 3. Method 500 can be encoded in instructions that can be executed by image processing unit 190 and stored in one or more non-transitory computer-readable media. Method 500 can be implemented as part of firmware for image processing unit 190. Method 500 can be performed using a computing device, such as computing device 700 in FIG. 7.

In 502, a tone-mapping function is estimated. In some embodiments, estimating the tone-mapping function comprises estimating a parameter of the tone-mapping function based on one or more of a subject signal level, a noise characteristic of the image sensor, and a target signal-to-noise ratio.

In 504, a brightness value for a subject of an image is determined based on the tone-mapping function and a characteristic of a filter being applied to the image. In some embodiments, determining the brightness value comprises determining an input value to the tone-mapping function that results in a tone-mapped brightness value of the subject of the image. In some embodiments, determining the brightness value comprises determining a noise amplification constraint based on one or more of a noise characteristic of the image and the characteristic of the filter, and increasing the brightness value based on the noise amplification constraint. In some embodiments, determining the brightness value comprises, based on an amount of highlight meeting a condition, increasing the brightness value towards a tone-mapped brightness value of the subject of the image. In some embodiments, determining the brightness value comprises calculating an interpolation parameter based on an amount of highlight in the image, and calculating the brightness value based on the interpolation parameter and a tone-mapped brightness value of the subject of the image.

In 506, an exposure setting for an image sensor is determined based on the brightness value.

### Example Result

FIG. 6 showcases an improvement on a captured image using a disclosed auto-exposure control technique, according to some embodiments of the disclosure. The scene being captured is a backlit scene containing a human face. A black bar has been added to image 602 and image 604 to protect the privacy of the subject.

Image 602 shows the result of a standard AE control algorithm that uses fixed luminance target brightness. Because the background is bright, the AE control algorithm increases exposure to lift the dark face region to the predefined minimal target brightness. Large portions of the backlit background exceed the dynamic range of the image sensor and become saturated, causing loss of highlight detail.

Image 604 shows the result of algorithm 400 and/or method 500 being implemented. The exposure setting is kept lower, preventing background saturation, while tone-mapping subsequently lifts the face brightness to the desired level.

The difference between image 602 and image 604 demonstrates how coordinating tone-mapping with exposure control allows the AE control system to preserve highlight information in a single-exposure capture, while still capturing the subject at an appropriate brightness.

### Example Computing Device

FIG. 7 is a block diagram of an apparatus or a system, e.g., an example computing device 700, according to some embodiments of the disclosure. One or more computing devices 700 may be used to implement the functionalities described with the FIGS. and herein. A number of components illustrated in FIG. 7 can be included in the computing device 700, but any one or more of these components may be omitted or duplicated, as suitable for the application. In some embodiments, some or all of the components included in the computing device 700 may be attached to one or more motherboards. In some embodiments, some or all of these components are fabricated onto a single system on a chip (SoC) die. Additionally, in various embodiments, the computing device 700 may not include one or more of the components illustrated in FIG. 7, and the computing device 700 may include interface circuitry for coupling to the one or more components. For example, the computing device 700 may not include a display device 706, and may include display device interface circuitry (e.g., a connector and driver circuitry) to which a display device 706 may be coupled. In another set of examples, the computing device 700 may not include an audio input device 718 or an audio output device 708 and may include audio input or output device interface circuitry (e.g., connectors and supporting circuitry) to which audio input device 718 or audio output device 708 may be coupled.

Computing device 700 may include processing device 702 (e.g., one or more processing devices, one or more of the same type of processing device, one or more of different types of processing devices). Processing device 702 may include electronic circuitry that processes electronic data from data storage elements (e.g., registers, memory, resistors, capacitors, quantum bit cells) to transform that electronic data into other electronic data that may be stored in registers and/or memory. Examples of processing device 702 may include a central processing unit (CPU), a graphics processing unit (GPU), an image processing unit, an image signal processor, a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a neural network hardware accelerator, a deep neural network hardware accelerator, etc. Processing device 702 may have synchronization primitives/resources such as hardware barriers for synchronization operations being executed on the processing device 702.

In some embodiments, processing device 702 can include or be image processing unit 190, as described with reference to FIGS. 1 and 3. Processing device 702 may implement one or more hardware, logic, firmware, or software components corresponding to image processing unit 190. In some examples, image processing unit 190 is a dedicated image signal processor, image processing unit, application-specific integrated circuit, or system-on-chip component to execute image processing operations. In other examples, image processing unit 190 may be implemented as one or more functional or logic blocks executed on processing device 702. Accordingly, references to operations performed by image processing unit 190 may correspond to operations performed by processing device 702, whether implemented as dedicated hardware, programmable logic, firmware, or instructions executed by processing device 702. In some embodiments, image processing unit 190 can be implemented as a standalone integrated circuit to perform one or more functions described herein. In some embodiments, image processing unit 190 can be integrated as a functional or circuit block within an SoC and as part of processing device 702, sharing resources such as memory, interconnect, and control logic with other processing components.

In some embodiments, memory 704 includes one or more non-transitory computer-readable media storing instructions executable to perform operations described with the FIGS. and herein. Memory 704 may include one or more non-transitory computer-readable media storing instructions executable to perform one or more operations described with algorithm 400 of FIG. 4. Memory 704 may include one or more non-transitory computer-readable media storing instructions executable to perform one or more operations described with method 500 of FIG. 5. Example parts, e.g., parts illustrated as part of image processing unit 190 in FIG. 3, may be encoded as instructions and stored in memory 704. The instructions stored in the one or more non-transitory computer-readable media may be executed by processing device 702.

In some embodiments, memory 704 may store data, e.g., data structures, binary data, bits, metadata, files, blobs, etc., as described with the FIGS. and herein. Memory 704 may store inputs, intermediate inputs, intermediate outputs, and outputs of the algorithm 400 of FIG. 4 and method 500 of FIG. 5. Memory 704 may store raw images and processed images of imaging system 100 described and illustrated in FIG. 1.

In some embodiments, computing device 700 may include a communication device 712 (e.g., one or more communication devices). For example, communication device 712 may be configured for managing wired and/or wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Communication device 712 may implement any of a number of wireless standards or protocols. Computing device 700 may include antenna 722 to facilitate wireless communications and/or to receive other wireless communications (such as radio frequency transmissions). Computing device 700 may include receiver circuits and/or transmitter circuits. In some embodiments, communication device 712 may manage wired communications, such as electrical, optical, or any other suitable communication protocols (e.g., the Ethernet). As noted above, communication device 712 may include multiple communication chips. For instance, a first communication device 712 may be dedicated to shorter-range wireless communications. In some embodiments, a first communication device 712 may be dedicated to wireless communications, and a second communication device 712 may be dedicated to wired communications.

Computing device 700 may include power source/power circuitry 714. The power source/power circuitry 714 may include one or more energy storage devices (e.g., batteries or capacitors) and/or circuitry for coupling components of the computing device 700 to an energy source separate from the computing device 700 (e.g., DC power, AC power, etc.).

Computing device 700 may include a display device 706 (or corresponding interface circuitry, as discussed above). The display device 706 may include any visual indicators, such as a heads-up display, a computer monitor, a projector, a touchscreen display, a liquid crystal display (LCD), a light-emitting diode display, or a flat panel display, for example.

Computing device 700 may include audio output device 708 (or corresponding interface circuitry, as discussed above). Audio output device 708 may include any device that generates an audible indicator, such as speakers, headsets, or earbuds, for example.

Computing device 700 may include audio input device 718 (or corresponding interface circuitry, as discussed above). Audio input device 718 may include any device that generates a signal representative of a sound, such as microphones, microphone arrays, or digital instruments (e.g., instruments having a musical instrument digital interface (MIDI) output).

Computing device 700 may include GPS device 716 (or corresponding interface circuitry, as discussed above). GPS device 716 may be in communication with a satellite-based system and may receive a location of the computing device 700, as known in the art.

Computing device 700 may include sensor 730 (or one or more sensors). Computing device 700 may include corresponding interface circuitry, as discussed above). Sensor 730 may sense physical phenomenon and translate the physical phenomenon into electrical signals that can be processed by, e.g., processing device 702. Examples of sensor 730 may include: image sensor, capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 700 may include another output device 710 (or corresponding interface circuitry, as discussed above). Examples of the other output device 710 may include an audio codec, a video codec, a printer, a wired or wireless transmitter for providing information to other devices, haptic output device, gas output device, vibrational output device, lighting output device, home automation controller, or an additional storage device.

Computing device 700 may include another input device 720 (or corresponding interface circuitry, as discussed above). Examples of the other input device 720 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 700 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 700 may be any other electronic device that processes data.

### Select Examples

Example 1 provides an image processing unit, including a tone-mapping logic to apply a tone-mapping function to an image from an image sensor; a filtering logic to apply a filter to an output image from the tone-mapping logic; and an exposure control logic including a brightness value determination logic to determine a brightness value for a subject of the image based on the tone-mapping function and a characteristic of the filter; and an exposure setting determination logic to determine an exposure setting for the image sensor based on the brightness value.

Example 2 provides the image processing unit of example 1, where the brightness value determination logic includes a tone-mapping function determination logic to estimate a parameter of the tone-mapping function based on one or more of a subject signal level, a noise characteristic of the image sensor, and a target signal-to-noise ratio.

Example 3 provides the image processing unit of example 2, where the brightness value determination logic is to determine the brightness value based on the tone-mapping function and the parameter of the tone-mapping function.

Example 4 provides the image processing unit of any one of examples 1-3, where the brightness value determination logic is to determine the brightness value based on a noise amplification constraint, where the noise amplification constraint is based on one or more of a noise characteristic of the image and the characteristic of the filter.

Example 5 provides the image processing unit of any one of examples 1-4, where the brightness value determination logic is to determine the brightness value based on one or more of an amount of highlight in the image and a tone-mapped brightness value of the subject of the image.

Example 6 provides the image processing unit of any one of examples 1-5, where the brightness value determination logic includes a blending logic to determine a blending parameter for blending the brightness value and a tone-mapped brightness value of the subject of the image based on an amount of highlight in the image.

Example 7 provides the image processing unit of any one of examples 1-6, where the subject includes a face of a human.

Example 8 provides one or more non-transitory computer-readable media storing instructions that, when executed by an image processing unit, cause the image processing unit to: determine a brightness value for a subject of an image based on a tone-mapping function and a characteristic of a filter being applied to the image after the tone-mapping function is applied to the image; and determine an exposure setting for an image sensor based on the brightness value.

Example 9 provides the one or more non-transitory computer-readable media of example 8, where the image processing unit determines the brightness value by: estimating a parameter of the tone-mapping function based on one or more of a subject signal level, a noise characteristic of the image sensor, and a target signal-to-noise ratio.

Example 10 provides the one or more non-transitory computer-readable media of example 8 or 9, where the image processing unit determines the brightness value by: determining an input value to the tone-mapping function that results in a tone-mapped brightness value of the subject of the image.

Example 11 provides the one or more non-transitory computer-readable media of any one of examples 8-10, where the image processing unit determines the brightness value by: determining a noise amplification constraint based on one or more of a noise characteristic of the image and the characteristic of the filter; and adjusting the brightness value based on the noise amplification constraint.

Example 12 provides the one or more non-transitory computer-readable media of any one of examples 8-11, where the image processing unit determines the brightness value by: determining an amount of highlight in the image; and based on the amount of highlight meeting a condition, increasing the brightness value towards a tone-mapped brightness value of the subject of the image.

Example 13 provides the one or more non-transitory computer-readable media of any one of examples 8-12, where the image processing unit determines the brightness value by: adapting an interpolation parameter based on an amount of highlight in the image; and interpolating the brightness value and a tone-mapped brightness value of the subject of the image according to the interpolation parameter.

Example 14 provides the one or more non-transitory computer-readable media of any one of examples 8-11, where the subject includes a salient subject in the image.

Example 15 provides a method for auto-exposure control in a single-exposure pipeline, including estimating a tone-mapping function; determining a brightness value for a subject of an image based on the tone-mapping function and a characteristic of a filter being applied to the image; and determining an exposure setting for an image sensor based on the brightness value.

Example 16 provides the method of example 15, where estimating the tone-mapping function includes estimating a parameter of the tone-mapping function based on one or more of a subject signal level, a noise characteristic of the image sensor, and a target signal-to-noise ratio.

Example 17 provides the method of example 15 or 16, where determining the brightness value includes determining an input value to the tone-mapping function that results in a tone-mapped brightness value of the subject of the image.

Example 18 provides the method of any one of examples 15-17, where determining the brightness value includes determining a noise amplification constraint based on one or more of a noise characteristic of the image and the characteristic of the filter; and increasing the brightness value based on the noise amplification constraint.

Example 19 provides the method of any one of examples 15-18, where determining the brightness value includes based on an amount of highlight meeting a condition, increasing the brightness value towards a tone-mapped brightness value of the subject of the image.

Example 20 provides the method of any one of examples 15-19, where determining the brightness value includes calculating an interpolation parameter based on an amount of highlight in the image; and calculating the brightness value based on the interpolation parameter and a tone-mapped brightness value of the subject of the image.

Example 21 provides an apparatus including means for performing a method according to any one of examples 15-20.

Example 22 provides a computer program product including instructions which, when executed by a processor, cause the processor to perform a method according to any one of examples 15-20.

Example 23 provides machine-readable storage including machine-readable instructions, when executed, cause a computer to implement a method according to any one of examples 15-20.

Example 24 provides a computer program including instructions which, when the computer program is executed by a processing device, cause the processing device to carry out a method according to any one of examples 15-20.

Example 25 provides a computer-implemented system, including one or more processors, and one or more non-transitory computer-readable media storing instructions that, when executed by the one or more processors, cause the one or more processors to perform a method according to any one of examples 15-20.

### VARIATIONS AND REMARKS

Although the operations of the example method shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An image processing unit, comprising:
a tone-mapping logic to apply a tone-mapping function to an image from an image sensor;
a filtering logic to apply a filter to an output image from the tone-mapping logic; and
an exposure control logic comprising:
a brightness value determination logic to determine a brightness value for a subject of the image based on the tone-mapping function and a characteristic of the filter; and
an exposure setting determination logic to determine an exposure setting for the image sensor based on the brightness value.

2. The image processing unit of claim 1, wherein the brightness value determination logic comprises:
a tone-mapping function determination logic to estimate a parameter of the tone-mapping function based on one or more of a subject signal level, a noise characteristic of the image sensor, and a target signal-to-noise ratio.

3. The image processing unit of claim 2, wherein the brightness value determination logic is to determine the brightness value based on the tone-mapping function and the parameter of the tone-mapping function.

4. The image processing unit of claim 1, wherein the brightness value determination logic is to determine the brightness value based on a noise amplification constraint, wherein the noise amplification constraint is based on one or more of a noise characteristic of the image and the characteristic of the filter.

5. The image processing unit of claim 1, wherein the brightness value determination logic is to determine the brightness value based on one or more of an amount of highlight in the image and a tone-mapped brightness value of the subject of the image.

6. The image processing unit of claim 1, wherein the brightness value determination logic comprises:
a blending logic to determine a blending parameter for blending the brightness value and a tone-mapped brightness value of the subject of the image based on an amount of highlight in the image.

7. The image processing unit of claim 1, wherein the subject comprises a face of a human.

8. One or more non-transitory computer-readable media storing instructions that, when executed by an image processing unit, cause the image processing unit to:
determine a brightness value for a subject of an image based on a tone-mapping function and a characteristic of a filter being applied to the image after the tone-mapping function is applied to the image; and
determine an exposure setting for an image sensor based on the brightness value.

9. The one or more non-transitory computer-readable media of claim 8, wherein the image processing unit determines the brightness value by:
estimating a parameter of the tone-mapping function based on one or more of a subject signal level, a noise characteristic of the image sensor, and a target signal-to-noise ratio.

10. The one or more non-transitory computer-readable media of claim 8, wherein the image processing unit determines the brightness value by:
determining an input value to the tone-mapping function that results in a tone-mapped brightness value of the subject of the image.

11. The one or more non-transitory computer-readable media of claim 8, wherein the image processing unit determines the brightness value by:
determining a noise amplification constraint based on one or more of a noise characteristic of the image and the characteristic of the filter; and
adjusting the brightness value based on the noise amplification constraint.

12. The one or more non-transitory computer-readable media of claim 8, wherein the image processing unit determines the brightness value by:
determining an amount of highlight in the image; and
based on the amount of highlight meeting a condition, increasing the brightness value towards a tone-mapped brightness value of the subject of the image.

13. The one or more non-transitory computer-readable media of claim 8, wherein the image processing unit determines the brightness value by:
adapting an interpolation parameter based on an amount of highlight in the image; and
interpolating the brightness value and a tone-mapped brightness value of the subject of the image according to the interpolation parameter.

14. The one or more non-transitory computer-readable media of claim 8, wherein the subject comprises a salient subject in the image.

15. A method for auto-exposure control in a single-exposure pipeline, comprising:
estimating a tone-mapping function;
determining a brightness value for a subject of an image based on the tone-mapping function and a characteristic of a filter being applied to the image; and
determining an exposure setting for an image sensor based on the brightness value.

16. The method of claim 15, wherein estimating the tone-mapping function comprises:
estimating a parameter of the tone-mapping function based on one or more of a subject signal level, a noise characteristic of the image sensor, and a target signal-to-noise ratio.

17. The method of claim 15, wherein determining the brightness value comprises:
determining an input value to the tone-mapping function that results in a tone-mapped brightness value of the subject of the image.

18. The method of claim 15, wherein determining the brightness value comprises:
determining a noise amplification constraint based on one or more of a noise characteristic of the image and the characteristic of the filter; and
increasing the brightness value based on the noise amplification constraint.

19. The method of claim 15, wherein determining the brightness value comprises:
based on an amount of highlight meeting a condition, increasing the brightness value towards a tone-mapped brightness value of the subject of the image.

20. The method of claim 15, wherein determining the brightness value comprises:
calculating an interpolation parameter based on an amount of highlight in the image; and
calculating the brightness value based on the interpolation parameter and a tone-mapped brightness value of the subject of the image.
